(19) United States
(12) Patent Application Publication
(10) Pub. No.: US 2026/0044780 A1
(43) Pub. Date: Feb. 12, 2026

(54) SYSTEM, METHOD, AND PROGRAM FOR CONSTRUCTING DATA SET FOR TRAINING AI MODEL THROUGH INSTRUCTION TUNING

(71) Applicant: LG MANAGEMENT DEVELOPMENT INSTITUTE CO., LTD., Seoul (KR)

(72) Inventors: Changho LEE, Seoul (KR); Janghoon HAN, Seoul (KR)

(21) Appl. No.: 19/360,984

(22) Filed: Oct. 17, 2025

Related U.S. Application Data
(63) Continuation of application No. PCT/KR2025/001944, filed on Feb. 10, 2025.

(30) Foreign Application Priority Data
Feb. 14, 2024 (KR) 10-2024-0021052
May 28, 2024 (KR) 10-2024-0069432

(51) Int. Cl. G06N 20/00

(52) U.S. Cl. CPC G06N 20/00

(57) ABSTRACT

A system, method, and program for constructing a data set that improves zero-shot learning performance of an AI model through instruction tuning extract instructions from each of a training task used for training an AI model, and a target task that is a task to be trained through the training task, evaluate similarity by comparing the extracted instruction of the training task with the extracted instruction of the target task, select, from among the extracted instructions of the training task, instructions having a similarities equal to or greater than a predetermined value, and output the selected instructions of the training task as a data set.

### CROSS REFERENCE TO RELATED APPLICATION(S)

This application is a continuation of International Application No. PCT/KR2025/001944, filed on Feb. 10, 2025, which claims the priority to Korean Patent Application No. 10-2024-0021052, filed on Feb. 14, 2024, and Korean Patent Application No. 10-2024-0069432, filed on May 28, 2024, which are all hereby incorporated by reference in their entireties.

### TECHNICAL FIELD

The present disclosure generally relates to a system, method, and program for constructing a data set for training an AI model through instruction tuning, and more particularly, to a system, method, and program for constructing a data set that improves the zero-shot learning performance of an AI model through instruction tuning.

### RELATED ART

In recent studies, instruction tuning has been established as a key approach to improve zero-shot learning performance.

By the zero-shot learning, an AI model may have a certain level of understanding and performance capability when an unseen task is presented in a situation where the model has never trained a specific task. A key factor that enables the zero-shot learning is the model's ability to understand a structure of data used during training and abstract the structure to generalize. For example, in the case of language models, by understanding instructions or instances included in tasks used for training and learning them as abstract concepts, the model can interpret and perform tasks even when unseen tasks are given.

To improve the capability of the zero-shot learning, it is important to train various tasks. And, it is also important to select and train training tasks having relevance to each target task. This is because training with the training tasks having no relevance to the target task may cause negative transfer, thereby degrading performance of the AI model.
(Non-Patent Document 1) Taskweb: Selecting better 662 source tasks for multi-task NLP, Joongwon Kim et al., 2023.
(Non-Patent Document 2) Exploring the benefits of training expert language models over instruction tuning, Joel Jang et al., 2023.

### SUMMARY

Some embodiments of the present disclosure may provide a system, method, and program for constructing a data set that improves zero-shot learning performance of an AI model through instruction tuning.

The technical problems to be solved by the present disclosure are not limited to the above-described objects, and other technical problems not mentioned herein will become more apparent to those skilled in the art from the following description.

A system for constructing a dataset according to an embodiment of the present disclosure includes at least one processor, and a memory storing one or more commands, wherein the at least one processor executes the one or more commands stored in the memory to perform extracting instructions from each of a training task used for training an AI model and a target task that is a task to be trained through the training task, evaluating similarity by comparing the extracted instruction of the training task with the extracted instruction of the target task, selecting, from among the extracted instructions of the training task, instructions having similarities equal to or greater than a predetermined value, and outputting the selected instructions of the training task as a data set.

In the system, the evaluating of the similarity may include representing the extracted instruction of the training task and the extracted instruction of the target task as vectors, and performing evaluation through cosine similarity that compares directional similarity between the two vectors.

In the system, the evaluating of the similarity may evaluate the similarity through a model transfer method, wherein the model transfer method may include training a model transfer AI model with any one of the extracted instructions of the training task, inputting a plurality of the extracted instructions of the target task to the model transfer AI model to evaluate performance of the model transfer AI model, and assigning a high similarity to the extracted instruction of the target task for which the model transfer AI model exhibits high performance and to the extracted instruction of the training task used for training the model transfer AI model.

In the system, the evaluating of the similarity may be performed by a task selector model that has been pre-tuned for evaluating the similarity, wherein the pre-tuning for evaluating the similarity may include selecting any one of a plurality of the target tasks as a first task, extracting a first instruction from the first task and designating the first instruction as a positive sample, selecting any other one of the plurality of the target tasks other than the first task as a second task, extracting a second instruction from the second task and designating the second instruction as a negative sample, assigning similarity scores to the positive sample and the negative sample, and training the task selector model using the positive sample and the negative sample including the similarity scores.

In the system, the assigning of the similarity scores to the positive sample and the negative sample may include assigning a similarity score of “1” to the positive sample and assigning a similarity score of “0” to the negative sample.

In the system, the extracting of the instructions may further include unifying placeholders included in the extracted instruction of the training task and the extracted instruction of the target task into specific terms.

A method for constructing a dataset according to another aspect of the present disclosure, which is a method for generating prediction data, performed by at least one processor, may include extracting instructions from each of a training task used for training an AI model and a target task that is a task to be trained through the training task, evaluating similarity by comparing the extracted instruction of the training task with the extracted instruction of the target task, selecting, from among the extracted instructions of the training task, instructions having similarities equal to or greater than a predetermined value, and outputting the selected instructions of the training task as a data set.

In the method, the evaluating of the similarity may include representing the extracted instruction of the training task and the extracted instruction of the target task as vectors, and performing evaluation through cosine similarity that compares directional similarity between the two vectors.

In the method, the evaluating of the similarity may evaluate the similarity through a model transfer method, wherein the model transfer method may include training a model transfer AI model with any one of the extracted instructions of the training task, inputting a plurality of the extracted instructions of the target task to the model transfer AI model to evaluate performance of the model transfer AI model, and assigning a high similarity to the extracted instruction of the target task for which the model transfer AI model exhibits high performance and to the extracted instruction of the training task used for training the model transfer AI model.

In the method, the evaluating of the similarity may be performed by a task selector model that has been pre-tuned for evaluating the similarity, wherein the pre-tuning for evaluating the similarity may include selecting any one of a plurality of the target tasks as a first task, extracting a first instruction from the first task and designating the first instruction as a positive sample, selecting any other one of the plurality of the target tasks other than the first task as a second task, extracting a second instruction from the second task and designating the second instruction as a negative sample, assigning similarity scores to the positive sample and the negative sample, and training the task selector model using the positive sample and the negative sample including the similarity scores.

In the method, the assigning of the similarity scores to the positive sample and the negative sample may include assigning a similarity score of “1” to the positive sample and assigning a similarity score of “0” to the negative sample.

In the method, the extracting of the instructions may further include unifying placeholders included in the extracted instruction of the training task and the extracted instruction of the target task into specific terms.

A program according to still another aspect of the present disclosure may be a program stored in a computer-readable recording medium to execute the method for constructing data set according to embodiments of the present disclosure on a computer.

According to some embodiments of the present disclosure, the efficiency of computing resource utilization can be improved and zero-shot learning capability can be enhanced, by providing a simple and effective method for selecting training tasks related to a target task.

In addition, according to certain embodiments of the present disclosure, similarity between instructions of target tasks and instructions of training tasks can be more accurately evaluated by training a task selector model that evaluates the similarity, and overall performance of a model can be improved by increasing the accuracy of training task selection.

In addition, according to some embodiments of the present disclosure, a negative effect of a placeholder on AI model training can be reduced or prevented by unifying a placeholder included in an extracted instruction into a specific term, thereby improving zero-shot performance.

The effects of the present disclosure are not limited to the above-described effects, and other effects not mentioned herein will be clearly understood by those skilled in the art from the following description.

### BRIEF DESCRIPTION OF DRAWINGS

FIG. 1 is a schematic diagram of a system for implementing a method for constructing a data set that improves zero-shot learning performance of an AI model through instruction tuning according to an embodiment of the present disclosure.

FIG. 2 is a block diagram for illustrating a configuration of a device for constructing a data set that improves the zero-shot learning performance of an AI model through instruction tuning according to an embodiment of the present disclosure.

FIG. 3 is a flowchart for illustrating a method for constructing a data set that improves the zero-shot learning performance of an AI model through instruction tuning according to embodiments of the present disclosure.

FIG. 4 shows results of evaluating the zero-shot learning performance of a data set constructed according to embodiments of the present disclosure.

FIG. 5 shows results of evaluating the zero-shot learning performance of a data set in which instructions of training tasks are selected based on similarity of a top n-th (where n is 1, 3, 5, or 10) rank or higher according to embodiments of the present disclosure.

FIG. 6 is a flowchart for illustrating a method of evaluating similarity using a task selector model that has been pre-tuned according to embodiments of the present disclosure.

FIG. 7 is code representing data including placeholders according to an embodiment of the present disclosure.

### DETAILED DESCRIPTION OF EMBODIMENTS

The following embodiments are provided as examples so that the spirit of the present invention can be sufficiently conveyed to those skilled in the art to which the present invention pertains. Therefore, the present invention is not limited to the embodiments described below and may be specified in other forms.

The same reference numerals refer to the same components throughout the present invention. The present invention does not describe all elements of the embodiments, and common content in the art to which the present invention pertains or content that overlaps between the embodiments will be omitted. Terms such as ‘unit,’ ‘module,’ ‘member,’ and ‘block’ used in the specification may be implemented as software or hardware, and according to the embodiments, a plurality of ‘units,’ ‘modules,’ ‘members,’ and ‘blocks’ may be implemented as one component, or one “unit,” ‘unit,’ ‘module,’ ‘member,’ and ‘block’ may also include a plurality of components.

Throughout the specification, when a first component is described as being “connected” to a second component, this includes not only a case in which the first component is directly connected to the second component but also a case in which the first component is indirectly connected to the second component, and the indirect connection includes connection through a wireless communication network.

In addition, when a certain portion is described as “including” a certain component, it means further including other components rather than precluding other components unless specifically stated otherwise.

Throughout the present specification, when a first member is described as being positioned “on” a second member, this includes both a case in which the first member is in contact with the second member and a case in which a third member is present between the two members.

Terms such as first and second are used to distinguish one component from another, and the components are not limited by the above-described terms.

A singular expression includes plural expressions unless the context clearly dictates otherwise.

In each operation, identification symbols are used for convenience of explanation, and the identification symbols do not describe the order of each operation, and each operation may be performed in a different order from the specified order unless a specific order is clearly described in context.

A system for constructing a data set that improves zero-shot learning performance of an AI model through instruction tuning according to an embodiment of the present disclosure may include a device comprising all types of devices capable of performing computation processing and providing computation processing results to a user. For example, the system for constructing the data set that improves the zero-shot learning performance of the AI model through the instruction tuning according to an embodiment of the present disclosure may include at least one of a computer, a server device, and/or a portable terminal, or may be implemented in any type of device capable of performing the same or similar functions thereof. However, the present disclosure is not limited thereto.

Here, the computer may include, for example, but not limited to, a notebook, a desktop, a laptop, a tablet personal computer (PC), a slate PC, etc., which are equipped with a web browser or a wireless and/or wired communicator.

The server device is a server configured to process information in communication with an external device, and may include, for instance, but not limited to, an application server, a computing server, a database server, a file server, a game server, a mail server, a proxy server, and a web server.

The portable terminal may be a wireless communication device with portability and mobility and may include any type of handheld-based wireless communication devices such as a personal communication system (PCS), a global system for mobile communications (GSM), a personal digital cellular (PDC), a personal handyphone system (PHS), a personal digital assistant (PDA), international mobile telecommunication-2000 (IMT-2000), code division multiple access-2000 (CDMA-2000), w-code division multiple access (W-CDMA), a wireless broadband internet (WiBro) terminal, a smart phone, a smart device and wearable devices such as a watch, a ring, a bracelet, an anklet, a necklace, glasses, contact lenses, or a head-mounted device (HMD).

Hereinafter, exemplary embodiments of the present disclosure will be described in detail with reference to the accompanying drawings.

Some embodiments of the present disclosure relate to a system, method, and program for constructing a data set for training an artificial intelligence (AI) model through instruction tuning, and more particularly, to a system, method, and program for constructing a data set that improves the zero-shot learning performance of an AI model through instruction tuning.

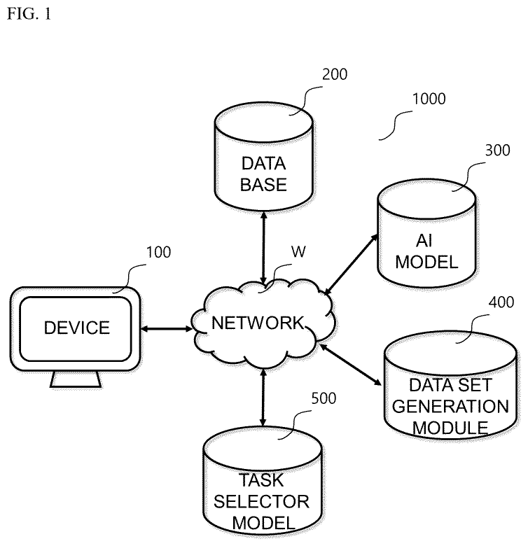

FIG. 1 is a schematic diagram of a system for constructing a data set for training an AI model through instruction tuning according to one embodiment of the present disclosure.

Referring to FIG. 1, a system 1000 may include a device 100, a database 200, an AI model 300, a data set generation module 400, and a task selector model 500.

One or more of the device 100, the database 200, the AI model 300, the data set generation module 400, and the task selector model 500, which are included in the system 1000, may be communicationally connected via a network W. The network W may include a wired network and a wireless network. For example, the network may include various networks such as a local area network (LAN), a metropolitan area network (MAN), and a wide area network (WAN).

In addition, the network W may also include the world wide web (WWW). However, the network W according to an embodiment of the present disclosure is not limited to the above-listed networks and may include a wireless data network, a telephone network, or a wired and/or wireless television network.

The device 100 may input data set generated by the data set generation module 400 into the AI model 300 or the task selector model 500 to perform training of the AI model 300 or the task selector model 500.

The data set generation module 400 may generate the data set through data output through the instruction tuning. The data set generated by the data set generation module 400 may be the same data set which is generally used for training the AI model or evaluating its performance. Preferably, the data set generated by the data set generation module 400 may be data set with improved zero-shot learning performance according to an embodiment of the present disclosure, but the present disclosure is not limited thereto. The data set generated by the data set generation module 400 includes instructions extracted from training tasks that have similarities equal to or greater than a predetermined value in similarity evaluation with instructions of a target task. Here, the instructions may include directives, information, or definitions of tasks (e.g., “Perform translation”), which are necessary to perform tasks, and an instance includes input data or examples used for model training (e.g., specific documents to be translated).

The database 200 may store various types of data (e.g., data sets) for training or evaluating the performance of the AI model 300. In addition, the database 200 may store the training tasks including the instructions and instances and the target tasks including the instructions and the instances. In an embodiment, the database 200 may store output data set output by the AI model 300. However, the system 1000 may not need or include the database 200 when the training of the AI model 300 is completed, although not required.

FIG. 1 shows an exemplary embodiment in which the database 200 is implemented as a database separate from the device 100. In this embodiment, the database 200 may be connected to the device 100 in a wired or wireless communication manner. However, this is only one embodiment for illustration purposes only, and the database 200 may be implemented as a part of the device 100.

FIG. 1 shows an exemplary embodiment in which the AI model 300 is not included in the device 100 (e.g., the AI model 300 is implemented in a cloud-based manner), but the present disclosure is not limited thereto, and the AI model 300 may be implemented as a part of the device 100.

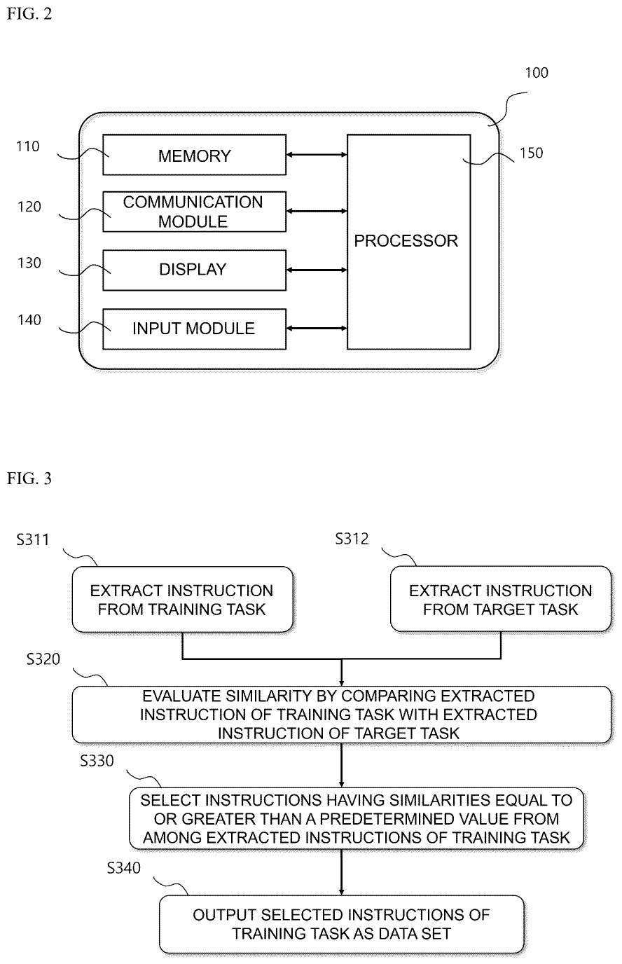

FIG. 2 is a block diagram for illustrating a configuration of a device for constructing a data set for training an AI model through instruction tuning according to an embodiment of the present disclosure.

Referring to FIG. 2, the device 100 of FIG. 1 may include a memory 110, a communication module or communicator 120, a display 130, an input module 140, and a processor 150. However, the present disclosure is not limited thereto, and software and hardware components of the device 100 may be modified, added, or omitted according to a required operation. In addition, the device 100 may be a system, and the device 100 may include a plurality of devices and each component included in the device 100 may be included in at least one of the plurality of devices.

The memory 110 may store data for performing various functions of the device 100 and a program for the operation of the processor 150, store input and/or output data, and store a plurality of application programs or applications that are executed or driven on the device, data, command, and the AI model for the operation of the device 100. At least some of the application programs may be downloaded from an external server via wireless communication.

The memory 110 may include any type of storage medium such as a flash memory type, a hard disk type, a solid state disk type (SSD type), a silicon disk drive type (SDD type), a multimedia card micro type, a card-type memory (e.g., an SD or XD memory), a random access memory (RAM), a static random access memory (SRAM), a read-only memory (ROM), an electrically erasable programmable ROM (EEPROM), a programmable ROM (PROM), a magnetic memory, a magnetic disk, and an optical disk.

Alternatively, the memory 110 may be implemented as being separate from the device 100, and may include a database that is connected in a wired or wireless communication manner. The database 200 shown in FIG. 1 may be implemented as one component of the memory 110.

The communication module or communicator 120 may include one or more components configured to perform communication with an external device, and may include at least one of, for example, but not limited to, a receiver, a transmitter, a transceiver, a broadcasting reception module, a wired communication module, a wireless communication module, a short-range communication module, or a position information module.

The wired communication module may include various types of wired communication modules such as a local area network (LAN) module, a wide area network (WAN) module, and a value added network (VAN) module and various types of cable communication modules such as a universal serial bus (USB), a high definition multimedia interface (HDMI), a digital visual interface (DVI), a recommended standard 232 (RS-232), power line communication, and plain old telephone service (POTS).

The wireless communication module may include an WiFi module, an wireless broadband (WiBro) module, and a wireless communication module configured to perform various wireless communication such as a global system for mobile communication (GSM), code division multiple access (CDMA), wideband CDMA (WCDMA), universal mobile telecommunications system (UMTS), time division multiple access (TDMA), long term evolution (LTE), 4G, 5G, or 6G.

The display 130 outputs or displays information or data that is processed by the device 100, data that are input or output through the AI model 300, etc. In addition, the display 130 may display execution screen information of an application program (e.g., an application) executed by or driven on the device 100, or user interface (UI) or graphic user interface (GUI) information according to such execution screen information.

The input module 140 is configured to receive an input (e.g. information) from a user. When the user inputs information through the input module 140, the processor 150 may control the operation of the device 100 to correspond to the input information.

The input module 140 may include a hardware physical structure or key (e.g., a button located on at least one of a front surface, a back surface, and a side surface of the device, a dome switch, a jog wheel, a jog switch, etc.) and a software touch key or interface. For example, the touch key may include a virtual key, a soft key, or a visual key that is displayed on a touchscreen through software processing or may be a touch key provided in a portion other than the touchscreen. The virtual key or visual key may have various forms and may be displayed on the touchscreen, and may be formed as, for example, a graphic, text, an icon, a video, or combination thereof.

The processor 150 may comprise a memory configured to store data for an algorithm for controlling operations (e.g., train or execution of the AI model) of one or more components included in the device 100 or a program that reproduces the algorithm, and at least one processor configured to performs one or more operations using the data stored in the memory. For instance, the memory and the processor may each be implemented as separate chips or may be implemented as a single integrated chip.

In an embodiment, the system 1000 or the device 100 according to an embodiment of the present disclosure may include at least one processor, and in an embodiment in which the system 1000 or the device 100 includes a plurality of processors, the plurality of processors may be included in different devices 100. In addition, the processor 150 may control the operations of the components by combining any one or a plurality of the above-described components in order to implement various embodiments according to the present disclosure on the device 100.

FIG. 3 is a flowchart for illustrating a method for constructing a data set for improving the zero-shot learning performance of an AI model through instruction tuning according to an embodiment of the present disclosure.

Referring to FIG. 3, at steps S311 and S312, instructions are extracted from each of training tasks, which are data used for training the AI model, and a target task that is information about a task to be trained by the AI model through the training tasks. The training tasks and the target task may have been stored in the memory 110 of the device 100, but the present disclosure is not limited thereto. Each of the training tasks and the target task includes instructions and instances. For example, the instructions include directives, information, definitions of tasks, etc., which are necessary to perform the tasks, and the instances include input data or examples used for model training. For example, in a case of a task for ‘Sentiment Analysis,’ the instruction may be “Determine whether the sentiment expressed in the given text is positive, negative, or neutral,” and the instance may be “I really enjoyed this movie! (positive sentiment expression).” In addition, in a case of a task for ‘Text Classification,’ the instruction may be “Classify news articles into categories such as politics, sports, entertainment, or technology,” and the instance may be a ‘sports article.’ In addition, in a case of a task for ‘Question Answering (QA),’ the instruction may be “Provide a correct answer based on information for the given text and a question related to the text,” and the instance may be “Who is the author of the Harry Potter series? (question) J. K. Rowling (answer).” In addition, in a case of a task for ‘Text Summarization,’ the instruction may be “Generate a concise and coherent summary while maintaining the main information and topic of a long text document,” and the instance may be ‘an article about today's weather.’ In addition, in a case of a task for ‘Named Entity Linking (NEL),’ the instruction may be “Link entities recognized in the text to corresponding entries in a knowledge base or a database to provide additional context and information,” and the instance may be “Jeju Island is an island in South Korea.” (entity: Jeju Island, link: island in South Korea).

Next, at step S320, similarity is evaluated by comparing the extracted instruction of the training task with the extracted instruction of the target task.

For example, cosine similarity may be used for evaluating the similarity. The cosine similarity is a method for measuring similarity between two vectors in a vector space, and refers to a method of calculating similarity by measuring how similar directions of two vectors are. The cosine similarity uses how ‘similar’ directions two vectors have. For instance, the cosine similarity is calculated using a following equation:

$$Cosine Similarity ( A , B ) = \frac{A \cdot B}{‖ A ‖ ‖ B ‖}$$

The range of the cosine similarity may be from −1 to 1, where a value of the cosine similarity closer to 1 indicates that the directions of two vectors are more similar and a value of the cosign similarity closer to −1 indicates that the directions of two vectors are dissimilar. And, when a value of the cosine similarity is 0, two vectors are orthogonal (i.e., a 90-degree angle) and have no directional similarity. In an embodiment of the present invention, each of the extracted instruction of the training task and the extracted instruction of the target task may be represented as a vector, and the similarity may be calculated using two vectors, one vector for the extracted instruction of the training task and the other vector for the extracted instruction of the target task.

In addition, model transfer may be used for evaluating the similarity. The model transfer may calculate similarity in a manner of evaluating performance by training a model with the extracted instruction of the training task and inputting the extracted instruction of the target task into the trained model. When the extracted instruction of the target task is input into the trained model, the higher the performance exhibited, the higher the similarity may be evaluated between the extracted instruction of the target task and the extracted instruction of the training task. That is, high similarities are assigned to the extracted instructions of the target tasks and the extracted instructions of the training tasks in the order of exhibiting high performance values when the extracted instruction of the target task is input into the trained model.

Here, accuracy, loss function, and the like may be used as indicators for measuring the performance values of the model.

The accuracy represents a ratio of samples that the model correctly classified and may be calculated as follows.

$$Accuracy = \frac{the number of correctly classified samples}{the total number of samples}$$

For example, when the extracted instructions of the target task are input into the trained model, the accuracy may be calculated by dividing the number of samples for which correct results are output by the total number of the extracted instructions of the target task, and the calculated accuracy may be used as the similarity.

The loss function may be a function for measuring the difference between a predicted value of a model and an actual value. For instance, mean squared error (MSE), cross-entropy loss, and the like may be used in the loss function. In a regression problem, the MSE may be used to measure an error between the predicted value of the model and the actual value, and in a classification problem, the cross-entropy loss may be used to measure the difference between a predicted probability distribution of the model and an actual distribution.

Next, at step S330, instructions having similarities equal to or greater than a predetermined value are selected from among the extracted instructions of the training task. Here, the ‘predetermined value’ may be a similarity ranking, a specific score of the similarity, and the like. For example, the predetermined value may be ‘the top 5th ranking or higher in similarity (similarity ranking) among the instructions of the training tasks’, or ‘the similarity score of 10 points or higher (specific score of similarity) among the instructions of the training tasks’, and the like.

Next, at step S340, the instructions of the training tasks, selected at step S330, are output as a data set. The data set may be used for training the AI model and may be stored in the database 200 of the system 1000 in order to train the AI model. Since an instruction includes information that defines characteristics of a task, a data set including only the selected instructions of the training tasks (i.e., a data set that does not include instances) may be sufficient to train the AI model. Rather, when the training is performed with a data set that includes the instances as well as the instructions, there may be a risk that various contents included in tasks may cause negative transfer in the training to degrade the zero-shot performance, and an operation for selecting relevant tasks from the tasks may be required.

Therefore, an embodiment of the present disclosure may provide a method for selecting training tasks related to a target task in a simple and effective way, thereby improving computing resource utilization efficiency and enhancing the zero-shot learning capability.

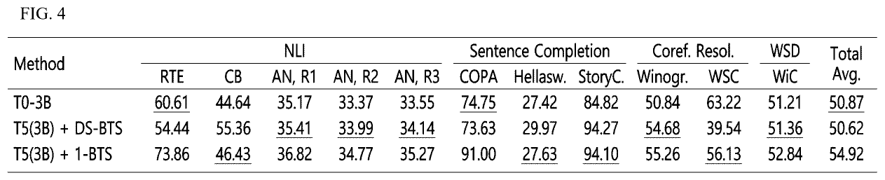

FIG. 4 shows results of evaluating the zero-shot learning performance of a case {T5(3B)+DS-BTS} of training using a data set including both instructions instances and a case {T5(3B)+I-BTS} of training using a data set including only instructions of training tasks selected according to an embodiment of the present disclosure. The data set used as tasks is P3 (Public Pool of Prompts) (Multitask prompted training enables zero-shot task generalization, Victor Sanh et al., 2022), and P3 includes a total of 35 tasks across 8 task clusters for training and each task includes an average of 11.7 instructions. In the evaluation results, NLI (natural language inference), Sentence Completion, Coreference Resol. (Coreference Resol.), and WSD (word sense disambiguation) are major categories of the target task, and RTE (recognizing textual entailment), CB (commonsense based), COPA (choice of plausible alternatives), and the like are subcategories of the target task.

‘T0-3B’ represents a model trained on all data without any selection based on the similarity, ‘T5(3B)+DS-BTS’ refers to a model trained by selecting 5 tasks with the highest similarities calculated by extracting some data as samples and using both the instructions and the instances included in the corresponding tasks according to conventional technology, and ‘T5(3B)+I-BTS’ refers to a model trained by selecting 5 tasks with the highest similarities and using only the instructions included in the tasks according to an embodiment of the present disclosure.

The scores that have evaluated the zero-shot learning performance shows that the performance scores of ‘T5(3B)+I-BTS’ according to an embodiment of the present disclosure are higher than the performance scores of ‘T5(3B)+DS-BTS’ according to convention technology in most tasks, and an average performance score of ‘T5(3B)+I-BTS’ according to an embodiment of the present disclosure (54.92 points) is is 4.3% higher than that of ‘T5(3B)+DS-BTS’ according to conventional technology (50.62 points).

These results provided in FIG. 4 show that instances in tasks may cause negative transfer in training to degrade model performance, and accordingly, training the AI model with only the instructions of the training tasks as in an embodiment of the present disclosure may improve the zero-shot performance.

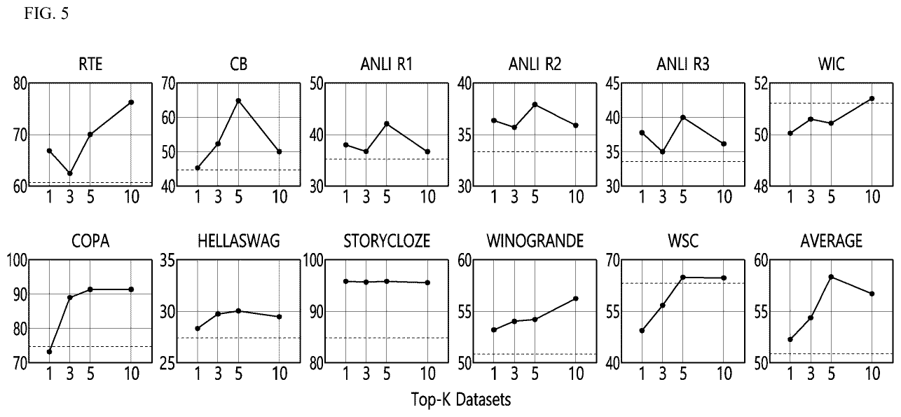

FIG. 5 shows results of evaluating zero-shot learning performance for a case in which instructions are selected based on similarities of the top n-th (where n is 1, 3, 5, or 10) rank or higher when selecting instructions having similarities equal to or greater than a predetermined value among the extracted instructions of the training tasks at step S330. According to the graphs shown in FIG. 5, the zero-shot learning performance gradually improves from a case of selecting the top 1st task to a case of selecting the top 5th task. However, FIG. 5 shows a tendency that the zero-shot learning performance decreases in a case of selecting the top 10th task in some tasks. Accordingly, it is preferable to select instructions based on similarity of the top 5-th rank or higher when selecting instructions based on similarity of the top n-th (where n is 1, 3, 5, or 10) rank or higher, but the present disclosure is not limited thereto.

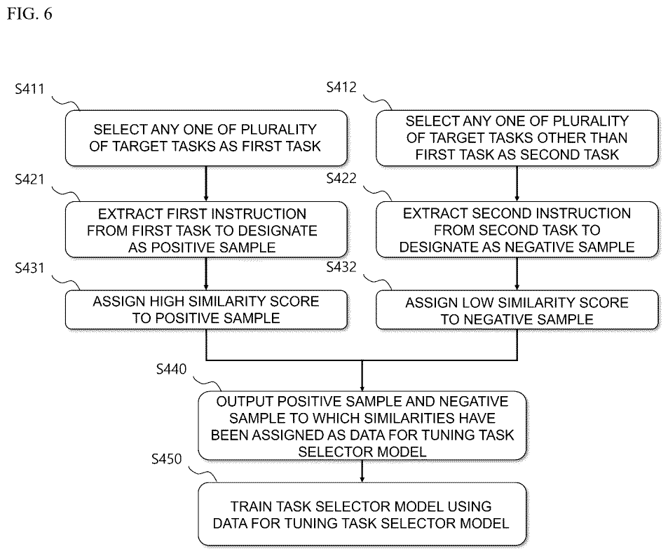

FIG. 6 is another example of a method for evaluating similarity (e.g., step S320 of FIG. 3) and is a flowchart for illustrating a method for evaluating similarity using a task selector model that has been pre-tuned. The task selector model may be a separate AI model that has been pre-trained for more accurate similarity evaluation.

Referring to FIG. 6, at step S411, one of a plurality of the target tasks is first selected as a first task, and, at step S421, a first instruction is extracted from the first task to designate as a positive sample. In addition, at step S412, one of the plurality of target tasks other than the first task is selected as a second task, and, at step S422, a second instruction is extracted from the second task to designate as a negative sample.

Next, at step S431, a high similarity score is assigned to the positive sample, and, at step S432, a low similarity score is assigned to the negative sample. Since the positive sample is extracted from the first task, the positive sample may be considered to have a relatively high degree of similarity to the first task, and since the negative sample is extracted from another task other than the first task, the negative sample may be considered to have a relatively low degree of similarity to the first task. Accordingly, a higher similarity score is assigned to the positive sample having higher similarity, and a lower similarity score is assigned to the negative sample having lower similarity.

The similarity scores may be assigned differently depending on the user, and in one embodiment, a similarity score of “1” may be assigned to the positive sample and a similarity score of “0” may be assigned to the negative sample. As such, the similarity scores for the positive sample and negative sample may be set and assigned by the user, but the present disclosure is not limited thereto. For example, the method of evaluating the similarity described above as well as a method of vectorizing the positive sample and negative sample and calculating the Euclidean distance between the two vectors and the like may be used. In addition, a natural language processing-based approach that assigns scores by measuring similarity between sentences using techniques such as sentence embedding, tokenization, morphological analysis, and the like may be used. In addition, the user may additionally tune the calculated similarity scores so that a higher similarity is assigned to the positive sample and a lower similarity is assigned to the negative sample.

Next, at step S440, the positive sample and the negative sample to which similarities have been assigned are output as data for tuning the task selector model, and, at step S450, the task selector model is trained using the data for tuning the task selector model. Since clearly distinguishable similarities are assigned to the positive sample and the negative sample according to the similarities of the first and second instructions, respectively, by training the task selector model using these, the task selector model can be tuned to more clearly distinguish the similarity between the instruction of the target task and the instructions of the training tasks.

Therefore, according to an embodiment of the present disclosure, the similarity between instructions of the target tasks and instructions of the training tasks can be more accurately evaluated by additionally training the task selector model that evaluates the similarity, and furthermore, overall performance of the task selector model can be improved by increasing the accuracy of training task selection.

Meanwhile, the operations of extracting the instructions (e.g., steps S311 and S312 of FIG. 3) may further include an operation of unifying placeholders included in the extracted instructions into the same sentence.

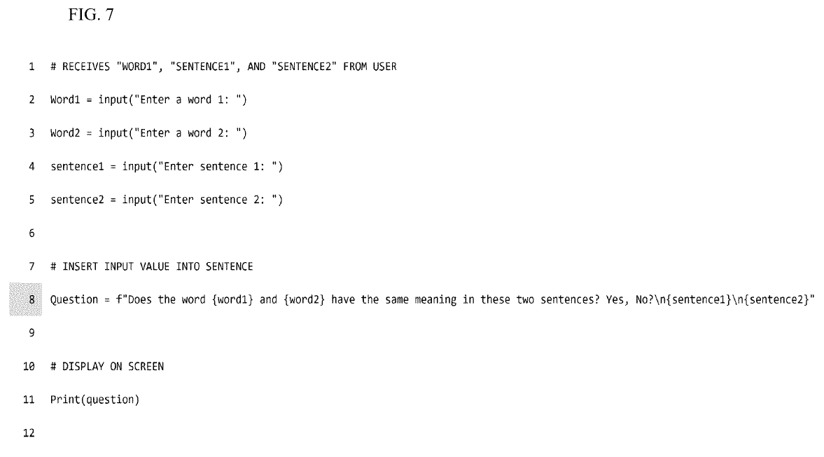

The placeholders refer to a code temporarily inserted at a location where elements such as characters, images, and the like included in data are placed. For example, data of “question” (“Does the word {{word1}} and {{word2}} have the same meaning in these two sentences? Yes, No?\n {{sentence1}}\n {{sentence2}}”) included in the code as shown in FIG. 7 receives “word1”, “word2”, “sentence1”, and “sentence2” that are input by the user to output completed data. Here, {{word1}}, {{word2}}, {{sentence1}}, and {{sentence2}} correspond to the placeholders that are temporarily inserted at the locations where user input values are placed.

Since the placeholder may not only have an inconsistent form but also have an unclear meaning, data including the placeholder may have a negative effect on a training process of the AI model. Accordingly, when the placeholder included in data for training the AI model is unified into a specific term, such negative effect may be reduced or removed.

For example, the placeholders may be identified and removed through data pre-processing. In FIG. 7, {{word1}} and {{word2}} included in the data may be unified into {{text}}, and {{sentence1}} and {{sentence2}} may be unified into {{candidate}}. Methods for identifying and removing the placeholders include a method in which a user identifies and removes the placeholders by oneself, a method of tokenizing text and identifying and removing segmented placeholders, a method of identifying and removing the placeholders by recognizing patterns of the placeholders, and the like, but the present disclosure is not limited thereto.

Therefore, according to an embodiment of the present invention, the negative effect of the placeholder on AI model training can be prevented by unifying the placeholder included in an extracted instruction into a specific term, thereby improving zero-shot performance.

The instruction tuning according to an embodiment of the present disclosure may select training tasks related to a target task, which refers to strengthening training for an AI model and enable efficient execution of complex tasks, and more specifically, the instruction tuning includes adjusting parameters and directives to improve the operation of AI algorithms. The instruction tuning may improve AI training efficiency using a simple computerized method and, particularly, an unseen task may be generalized.

The training or target tasks used in an embodiment of the present disclosure and the instructions extracted therefrom may be configured to be suitable for performing in-context learning (ICL) by being classified into groups that perform the same task, thereby enabling in-depth learning for a specific domain.

In-Context Learning may be a method of conducting learning by extracting only a portion of data included in downstream tasks and using the context, and is classified into zero-shot learning, one-shot learning, and few-shot learning. As the number of parameters of a language model significantly increases, a large language model (LLM) may learn through context included in examples, and accordingly, it is possible to enable the LLM to predict results by inputting several examples into the pre-trained LLM. More specifically, in-context may refer to a contextual information in a prompt, which may be related to, for example, arithmetic operations, typo correction, language translation, and the like. For example, in a task of summarizing conversation content, a few-shot learning method using prompt examples as well as the zero-shot learning method that is controlled through instructions without prompt examples, a learning method based on fine-tuning, and the like may be utilized. Therefore, the LLM (e.g., GPT-3, HyperClova, etc.) may be an excellent zero-shot or few-shot learner that is controlled through prompts, and may solve a natural language processing (NLP) problem by understanding context or patterns included in small amounts of data through prompts. Such learning method has the advantage of not requiring parameter updates and reducing computational loss.

The method for constructing the data set for training the AI model through the instruction tuning according to some embodiments of the present disclosure may be implemented by the system described with reference to FIG. 1.

The AI models according to certain embodiments of the present disclosure may be controlled, executed, trained, driven, etc. by at least one processor, and accordingly, at least one of the tasks of executing, training, and driving the AI models may be performed by at least one processor. In addition, the AI models may be stored in the memory, and the feature data according to some embodiments of the present disclosure may be stored in the memory.

Meanwhile, disclosed embodiments may be implemented in the form of a recording medium in which computer-executable commands are stored. The commands may be stored in the form of program code, and when executed by the processor, program modules may be generated to perform operations of the disclosed embodiments. The recording medium may be implemented as a computer-readable recording medium.

The computer-readable recording medium includes all types of recording media in which computer-decodable commands are stored. For example, there may be a read only memory (ROM), a random access memory (RAM), a magnetic tape, a magnetic disk, a flash memory, an optical data storage device, and the like.

As described above, the disclosed embodiments have been described with reference to the accompanying drawings. Those skilled in the art to which the present disclosure pertains will understand that the present disclosure may be implemented in different forms from the disclosed embodiments without departing from the technical spirit or essential features of the present disclosure. The disclosed embodiments are illustrative and should not be construed as being limited.

What is claimed is:

1. A system comprising:
memory storing one or more commands; and
at least one processor is configured to execute the one or more commands stored in the memory to perform operations comprising:
extracting instructions from each of a training task used for training an artificial intelligence (AI) model and a target task that is a task to be trained through the training task;
evaluating similarities by comparing the extracted instructions of the training task with the extracted instructions of the target task;
selecting, from among the extracted instructions of the training task, instructions having similarities equal to or greater than a predetermined value; and
outputting the selected instructions of the training task as a data set.

2. The system of claim 1, wherein
the evaluating of the similarities includes representing the extracted instructions of the training task and the extracted instructions of the target task as vectors, and evaluating the similarities by comparing directional similarity between two of the vectors.

3. The system of claim 1, wherein
the evaluating of the similarities comprises:
training a model transfer AI model with one of the extracted instructions of the training task;
inputting a plurality of the extracted instructions of the target task to the model transfer AI model to evaluate performance of the model transfer AI model;
assigning a higher similarity to an extracted instruction of the target task in which the performance of the model transfer AI model is evaluated higher and to an extracted instruction of the training task which is used for training the model transfer AI model.

4. The system of claim 1, wherein
the extracting of the instructions includes unifying placeholders included in the extracted instructions of the training task and the extracted instructions of the target task into specific terms.

5. A computerized method comprising:
extracting instructions from each of a training task used for training an AI model and a target task that is a task to be trained through the training task;
evaluating similarities by comparing the extracted instructions of the training task with the extracted instructions of the target task;
selecting, from among the extracted instructions of the training task, instructions having similarities equal to or greater than a predetermined value; and
outputting the selected instructions of the training task as a data set.

6. The computerized method of claim 5, wherein
the evaluating of the similarities includes representing the extracted instructions of the training task and the extracted instructions of the target task as vectors, and evaluating the similarities by comparing directional similarity between two of the vectors.

7. The computerized method of claim 5, wherein
the evaluating of the similarities comprises:
training a model transfer AI model with one of the extracted instructions of the training task;
inputting a plurality of the extracted instructions of the target task to the model transfer AI model to evaluate performance of the model transfer AI model; and
assigning a higher similarity to an extracted instruction of the target task in which the performance of the model transfer AI model is evaluated higher and to an extracted instruction of the training task which is used for training the model transfer AI model.

8. The computerized method of claim 5, wherein
the extracting of the instructions includes unifying placeholders included in the extracted instructions of the training task and the extracted instructions of the target task into specific terms.

9. A system comprising:
memory configured to store one or more commands; and
at least one processor configured to execute the one or more commands stored in the memory to perform operations comprising:
selecting, as a first task, one of a plurality of target tasks including at least an instruction and an instance;
extracting a first instruction from the first task and storing the first instruction as a positive sample in samples;
assigning a similarity score to each of the samples; and
training an instruction similarity evaluation model by using each of the samples including the similarity score.

10. The system of claim 9, wherein the at least one processor is further configured to:
select, as a second task, one other than the first task among the plurality of the target tasks; and
extract a second instruction from the second task and including the second instruction as a negative sample in the samples.

11. The system of claim 10, wherein
the assigning of the similarity score includes assigning a similarity score of a first value to the positive sample and assigning a similarity score of a second value lower than the first value to the negative sample.

12. A non-transitory computer-readable storage medium having instruction to execute the computerized method of claim 5.
